(19) United States
(12) Patent Application Publication
(10) Pub. No.: US 2010/0330346 A1
(43) Pub. Date: Dec. 30, 2010

(54) Article with an Image Displayed Thereon and Method of Transferring Images onto Articles

(76) Inventor: Philip Leapold Charles Fischer, Chapel Hill, NC (US)

Correspondence Address: WARD AND SMITH, P.A., 1001 COLLEGE COURT, P.O. BOX 867, NEW BERN, NC, 28563-0867, US

(21) Appl. No.: 12/492,737

(22) Filed: Jun. 26, 2009

(51) Int. Cl. B32B 3/10; B41C 1/06

(52) U.S. Cl. 428/195.1; 101/34

(57) ABSTRACT

A method and article involve calibrating a digital image for transfer to a hard surface for display thereon. A calibration table is created for calibrating a printer. A digital image, using the calibration settings is printed in mirror form onto a transfer sheet. The image is then transferred to the surface and polished to result in the article.

### FIELD OF THE INVENTION

This invention relates to digital image printing that uses a transfer sheet that transfers toner from the transfer sheet to a hard surface. The invention also relates to calibration of digital images to ensure accurate representations upon printing. The invention also relates to an article of manufacture with an image thereon.

### BACKGROUND OF THE INVENTION

Transfer sheets, for example, as described in U.S. Pat. Nos. 6,358,660, 6,410,200, 6,565,695, 6,723,773, 6,857,735, and known from products such as FlexiTrans HTHS available commercially from Transfer Technology (web page: http://www.transfertechnology.com/laserpaperDR.html#hths)) are used to transfer images from color laser printers to other materials such as cloth and metal. However, such transfer sheets used in this process transfer only the toner.

The color transferred often doesn't accurately represent the digital image, depending on the surface to which the image is transferred. It is also noted that in order to achieve an accurate representation, the images are printed onto the transfer sheet in a mirrored fashion. More specifically, the transfer sheet is placed on the surface to receive the image. Heat and pressure are applied to transfer the toner from the transfer sheet to the receiving surface. Texture is introduced in a conventional manner to the printed surface during the transfer process. The texture causes the image to have different appearances from different viewing angles when transferred to glossy surfaces, which is undesirable.

In light of the above, there is a need in the art for a method that reduces the texture without changing the color or brightness of the transferred image, and accounting for the type of surface onto which the image is transferred. Current methods involve polishing the transferred image to reduce the texture and improve the image quality. However, because the polishing removes toner, this changes the image color and brightness. As a result, the image must be printed darker than a non-polished image.

### BRIEF SUMMARY OF THE INVENTION

In accordance with one aspect, the present invention consists of two steps. The first step uses precise calibrations to make the image darker. The second step polishes the image to remove the extra toner from the darkened image and to remove texture.

In accordance with one aspect of the invention, an article for displaying images is provided. A shaped piece, typically of stainless steel, includes a mirror finish surface. An image is provided on at least a portion of the mirror finish surface. The image has been transferred onto the portion of the mirror finish surface through a dry transfer process, and then polished.

In another aspect, there is provided a method of manufacturing an article for displaying images. The method includes providing a surface, typically a stainless steel surface, as an article for having an image applied thereon. A digital image is created and printed onto a transfer sheet as a mirror of the original image. The image is then transferred onto the stainless steel surface and polished. In a preferred aspect, prior to transferring the image onto the surface, the surface has been textured, and after the image transfer, the article is baked. After baking, the image is polished and preferably covered with a protective coating.

In another aspect, there is provided a method for calibrating a digital image prior to printing onto a transfer sheet for eventual transfer to a hard surface. A calibration image is printed in a gray scale onto a transfer sheet and transferred to a hard surface. The surface is polished to reduce texture. The polished image is then photographed to produce a color digital image thereof. Color values for the gray scale are stored and a calibration transformation table is built for each color from gray scale data. Digital images may then be calibrated using the calibration table for ensuring that images transferred onto a surface closely match the original digital image.

### BRIEF DESCRIPTION OF THE DRAWINGS

Having briefly described the invention, the same will become better understood from the following detailed description taken with reference to the appended drawings, wherein:

FIG. 1 illustrates a shaped article in accordance with the invention in perspective view for displaying an image thereon;

FIG. 2 is a front view of the article of the invention showing an image thereon;

FIG. 3 is a block diagram illustrating calibration of images for eventual transfer onto a surface in accordance with the invention;

FIG. 4 is a block diagram illustrating the steps involved in transferring a digital image onto a surface in a long lasting and durable manner; and

FIG. 5 is an example of a calibration image in accordance with the invention.

### DETAILED DESCRIPTION OF THE INVENTION

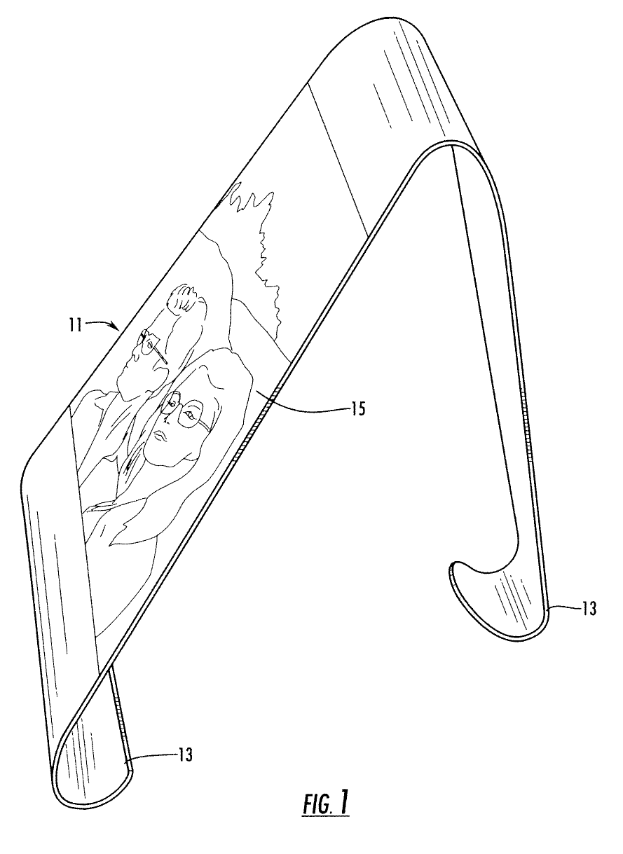

In accordance with one aspect of the invention, there is shown a shaped article for displaying images thereon. The shaped article as illustrated in FIG. 1 is typically of stainless steel, including a surface, the steel has been shaped and cut with the edges laser finished and ground to avoid a dangerous cutting surface and shaped to include at least one base 13, and preferably two bases 13 for supporting the article in an upright position to display an image.

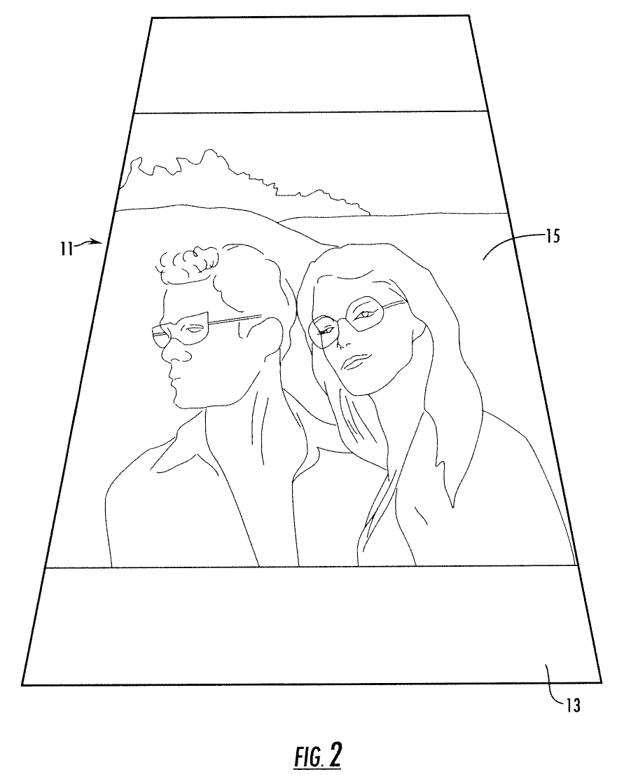

FIG. 2 illustrates the article 11 in accordance with the invention with an image 15 transferred thereon. Preferably the digital image transferred to be displayed as an image 15 on the article 11 has been calibrated prior to the transfer process and made as a mirror version printed to an image transfer sheet prior to transfer onto the article 11. The image 15 is then polished in a conventional manner.

In accordance with one or more further embodiments of the present invention, a method allows for the transfer of a digital image onto a hard surface with improved image quality.

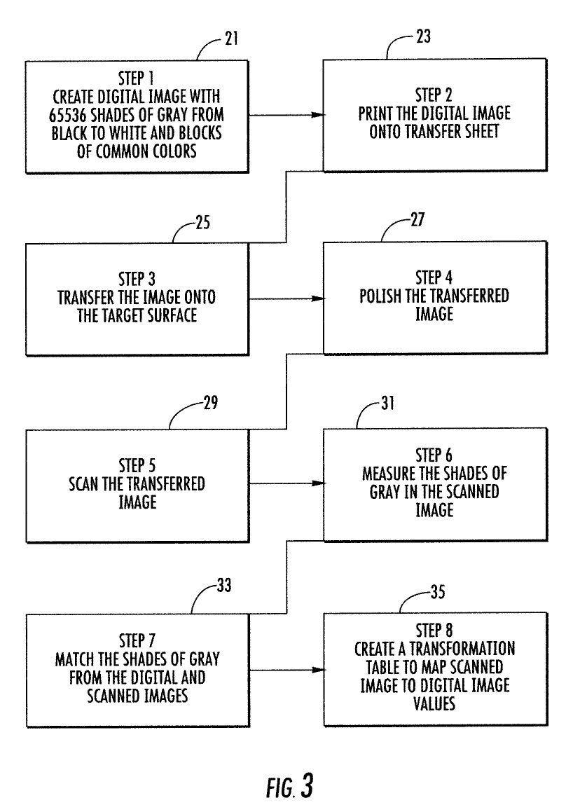

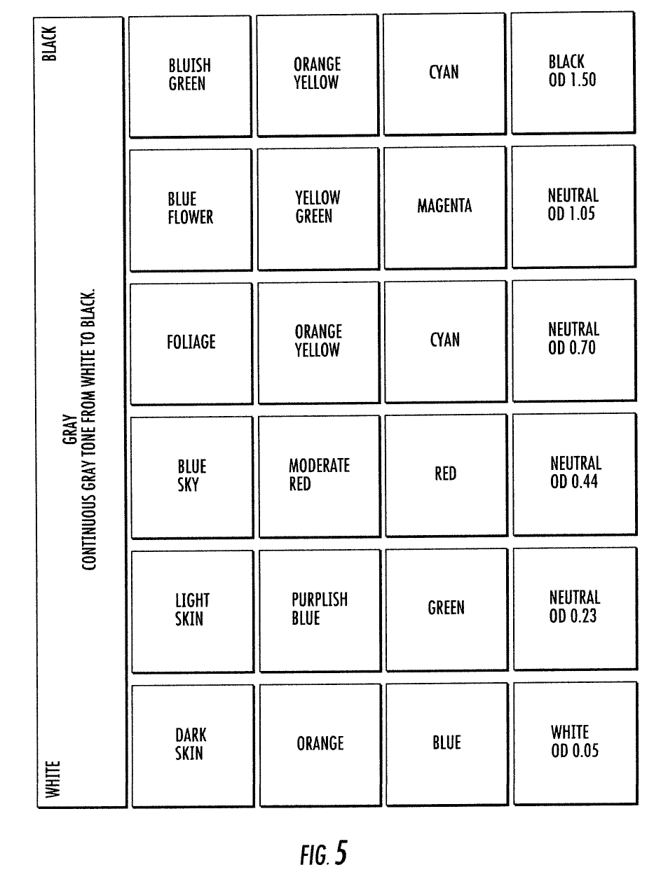

In a first process as illustrate in FIGS. 3 and 5, a first step is to create a calibration image 21 and then print 23 the calibration image, illustrated by FIG. 5, onto a transfer sheet. The calibration image of FIG. 5 is labeled at each block, as an alternative to showing color or grey scale, to represent a color or grey scale level. That image is transferred 25 to a desired hard surface. The calibration image must have a gray scale that goes from a black pixel value of 0, to a white pixel value of 65,535 (a 16-bit image). There also must be provided markers to show the start and end of the gray scale. The instructions for the transfer sheet which are conventional in nature should be followed for the transfer operation. Each different surface, printer and transfer sheet combination will have its own calibration. The media setting for a printer used should be set to the transfer sheet, if available. If the printer does not have a transfer sheet setting, then the printer should be set for a transparency sheet. If the printer does not have transfer sheet or transparency sheet settings, the printer should be set for glossy paper stock.

After the image has been transferred to the hard surface by following the instructions for the transfer sheet (including optional baking), the image is polished 27 until the texture has been reduced to an acceptable level. The acceptable level should be enough that the texture has been mostly removed, but that light colors are not completely removed.

The polished image is then photographed 29 so that a color digital image is produced. The digital camera used should produce a 16 bit per color (red, green and blue) digital image. The scan should be done so that gray range is horizontal or vertical. The digital image should be smoothed using a low pass filter in such a way that the gray values are averaged 90 degrees to the direction of the gray scale. The low pass filter will reduce noise in the printing/transfer process. The low passed color values for the gray scale are measured 31 and the results saved to a file that can be read by a spread sheet program.

For each color (red, green and blue) the data from the gray scale is used to build 35 a calibration transformation table. The input values for the calibration tables are the red, green and blue values at each pixel location. The output values for the calibration tables are the positions along the gray scale, scaled to 0 to 65535. A curve is fit to the data for each color. The output values are calculated 33 for integer input values of 0 to 65535 using curve fit data.

Using the calibration tables, a digital image is calibrated so that the final image will closely match the original digital image.

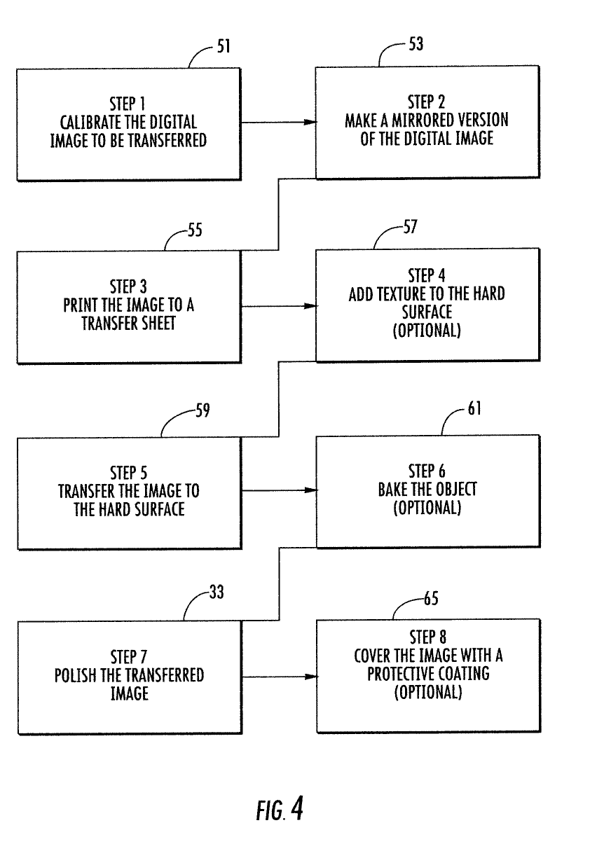

Once the calibration is achieved, in accordance with FIG. 3, the process involves first the afore-described calibration 51 of FIG. 4, followed by making 53 a mirrored version of the image to be transferred onto a dry transfer sheet so that when transferred to the final surface, the image to be transferred will be properly oriented.

The mirror image is printed 55 onto the transfer sheet. The same setting is used for the printer as used during the calibration process.

For a more artistic look texture may add 57 to the hard surface before printing. An example would be to add brush marks where hair would be transferred. An easy way to do this would be to print two transfer sheets. The image is then first transferred to the final surface. A tool such as a knife is used to scratch the hard surface to outline objects. Alternatively, a steel brush may be used to add texture for hair. After the texture is added to the hard surface, a solvent such as a lacquer thinner can be used to remove the image from the hard surface.

The final image from the second sheet is then transferred 59 to the hard surface following the transfer sheet's directions. If the transfer sheet instruction has a required or optional baking step 61, it is done at this stage.

The transferred image is polished 63 in the same way as the calibration image was polished. The polish should be abrasive enough to remove the toner, but not so abrasive as to scratch the hard surface. An example is Turtle Wax Polishing Compound. The polishing step will only work for transfers that only transfer toners. Most transfer sheets leave a protective coating/binding layer to hold ink in place. Toner-only transfer sheets work with laser type printers, not ink printers. Because the transfer process adds texture to the final image, the image quality is compromised. The texture is inherent in some of the transfer sheets and also in the heat/press process used to move the toner to the final hard surface.

If desired, a protective coating may be added 65 to the image. The protective coating could be used to protect the toner from scratching, ultra violet light or other environmental hazard.

What is claimed is:

1. An article for displaying images, comprising:
a shaped piece of stainless steel having a mirror finish surface; and
an image on at least a portion of the mirror finish surface, said image having been transferred to said at least a portion of the mirror finish surface.

2. The article of claim 1, wherein the mirror finish surface comprises a part of the shaped article, and another part comprises a base.

3. The article of claim 1, wherein said shaped piece of stainless steel has edges which are laser cut and then ground to be dulled.

4. The article of claim 1, wherein the article surface are polished after said image has been transferred thereon.

5. The article of claim 1, wherein said image has been transferred onto the portion of the mirror finish surface from a dry transfer sheet from a laser printer.

6. The article of claim 4, wherein the article has been baked prior to polishing.

7. The article of claim 6, wherein the image is covered with a protective coating.

8. The article of claim 1, wherein the article is shaped to have a base portion for supporting the article in an upright position displaying the image.

9. The article of claim 1, wherein the surface is textured prior to having had the image transferred thereon.

10. The article of claim 9, wherein the image has been polished and then covered with a protective coating.

11. A method of manufacturing an article for displaying images, comprising:
providing a surface as an article for having an image applied on a portion of a surface thereof;
creating a digital image;
printing the digital image onto a transfer sheet;
transferring the image onto the stainless steel surface; and
polishing the transferred image.

12. The method of claim 1, further comprising shaping the article to include a base for supporting the article in an upright position for displaying the image.

13. The method of claim 1, further comprising baking the article after transferring the image onto the surface, and before polishing.

14. The method of claim 1, further comprising covering the image with a protective coating.

15. The method of claim 1, further comprising adding texture to the surface before transferring the image onto the surface.

16. A method for calibrating a digital image prior to printing onto a transfer sheet, for transfer to a hard surface, comprising:
printing a calibration image in gray scale onto a transfer sheet;
transferring the calibration image to a hard surface;
polishing the image to reduce texture;
scanning the polished image to produce a color digital image;
storing the color values for the gray scale;
building a calibration transformation table for each color from gray scale data; and
calibrating digital images using the calibration table for ensuring that images eventually transferred onto a surface closely match the original digital image.
